(19) United States
(12) Patent Application Publication
(10) Pub. No.: US 2006/0265457 A1
(43) Pub. Date: Nov. 23, 2006

(54) Information processing apparatus and mail server for information processing apparatuses

(75) Inventor: Satoru Ueyama, Kato (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/202,339

(22) Filed: Aug. 12, 2005

(30) Foreign Application Priority Data
May 23, 2005 (JP) 2005-150143

(51) Int. Cl. G06F 15/16

(52) U.S. Cl. 709/206

(57) ABSTRACT

Before entering an unsafe area, the bearer of an information processing apparatus having a mail transmitting/receiving unit transmits an emergency mail message to a mail server and requests the message be transmitted out in case of emergency, thereby ensuring safety of the bearer. The information processing apparatus has a device which transmits a precreated specific message and its addressee to the mail server and requests the server to return at specified time a query message querying whether to transmit or not transmit the specific message to the addressee, and a device which requests the mail server, in response to the query message from the mail server, to cancel transmission of the specific message to the addressee; the mail server has a device transmits the query message at specified time and a device which transmits the specific message to the addressee if there is no reply to the query message.

### CROSS-REFERENCE TO RELATED APPLICATION

This application claims priority from, and incorporates by reference the entire disclosure of, Japanese Patent Application No. 2005-150143, filed on May 23, 2005.

### BACKGROUND OF THE INVENTION

1. Field of the Invention

The present invention relates to an information processing apparatus, to a mail server for an information processing apparatus and, more particularly, to an information processing apparatus and a mail server for information processing apparatuses wherein provisions are made so that, when any abnormality occurs in the condition of the user carrying the information processing apparatus, the condition can be reported to a preregistered third party by electronic mail.

2. Description of the Related Art

In recent years, communication apparatuses having a built-in computer have been reduced in size to the point where an information processing apparatus such as a mobile telephone can be easily carried around. An early type of such an information processing apparatus only had the function of transmitting and receiving voice, but a recent information processing apparatus is equipped with the function that can also transmit and receive data such as textual information and video information. Certain types of information processing apparatuses are equipped with the capability to connect to the Internet.

Of the many functions that have come to be incorporated into such information processing apparatuses, the function that is enjoying a high usage rate among the users of the information processing apparatuses is an electronic mail service. In this function, a plurality of alphabetic characters or hiragana or katakana characters are mapped to each key on the keypad of the information processing apparatus, enabling the user to enter a desired alphabetic character or hiragana or katakana character by pressing the designated key a few times. Further, when hiragana characters are entered, they can be converted into kanji by pressing a conversion key.

In such an electronic mail (hereinafter simply referred to as mail) system, when a mail message is created by the user, in most cases the mail message is sent out immediately; on the other hand, to meet various user needs, a mail apparatus that can send out a mail message at a different time and date than the time and date that the mail message was actually created is described in Japanese Unexamined Patent Publication No. 2000-305869.

Further, Japanese Unexamined Patent Publication No. 2003-244239 describes an information providing system in which a mail message carrying information entrusted from the outside and addressed to a designated user is delivered to the user at the specified time and date via a network by using data communication.

In recent years, with increasing security threats in our society, an increasing number of people have come to carry a self-protection device such as a crime prevention alarm, but when one actually encounters a dangerous situation, one may not be able to operate such a protection device on the spot. Further, in cases where a child goes out alone to a place where parents cannot keep an eye on the child, the child might face a threat of being kidnapped by a malicious adult.

However, when the user carrying an information processing apparatus is in a dangerous situation, if the information processing apparatus is equipped with the function described in the patent document 1 or 2, it has not been possible to notify a friend or the police that the user is facing a dangerous situation, because the user, if deprived of the information processing apparatus, cannot send a mail message.

### SUMMARY OF THE INVENTION

In view of the above situation, it is an object of the present invention to provide an information processing apparatus and a mail server for information processing apparatuses wherein provisions are made so that, before the user carrying the information processing apparatus enters an area that is considered not safe, or before a child goes out alone to a place where parents cannot keep an eye on the child, a mail message and the addressee of the message are preset by the user or by the parents so that when the user or the child encounters a dangerous situation, the mail message is automatically sent to the predesignated addressee, thereby securing the safety of the user or the child carrying the information processing apparatus.

According to a first mode of the present invention that achieves the above object, there is provided an information processing apparatus equipped with an electronic mail transmitting and receiving unit, comprising: a device which transmits a precreated specific mail message and an addressee thereof to a mail server and requests the mail server to return at a specified time a query message querying whether to send out or not send out the specific mail message to the addressee; and a device which requests the mail server, in response to the query message returned from the mail server, to cancel the transmission of the specific mail message to the addressee.

According to a second mode of the invention, the information processing apparatus of the first mode further comprises a device which requests the mail server, in response to the query message returned from the mail server, to cancel the transmission of the specific mail message for the present and requests again the mail server to return at another specified time a query message querying whether to send out or not send out the specific mail message.

According to a third mode of the invention, the specified time in the second mode is set as a plurality of different times.

According to a fourth mode of the invention, there is provided a mail server capable of transmitting and receiving mail messages to and from information processing apparatuses each having the same devices as the information processing apparatus described in any one of the first to third modes, the mail server comprising: a device which stores a specific mail message and monitors a specified reply time when the specific mail message, the addressee thereof, and the specified reply time are received from any particular information processing apparatus; a device which returns at the specified reply time a query message to the information processing apparatus that originated the specific mail message, and thereby querying the information processing apparatus as to whether or not the specific mail message should be sent out to the addressee; and a device which handles the specific mail message in accordance with a reply received from the information processing apparatus in response to the query message, or transmits the specific mail message to the addressee when no reply is received.

According to a fifth mode of the invention, the reply from the information processing apparatus in the fourth mode is a request to cancel the transmission of the specific mail message to the addressee, or a request to return at another specified time a query message querying whether to send out or not send out the specific mail message to the addressee.

According to a sixth mode of the invention, there is provided an electronic mail transmitting and receiving method for an information processing apparatus, comprising: transmitting a precreated specific mail message and an addressee thereof to a mail server; requesting the mail server to return at a specified time a query message querying whether to send out or not send out the specific mail message to the addressee; and requesting the mail server, in response to the query message returned from the mail server, to cancel the transmission of the specific mail message to the addressee.

According to a seventh mode of the invention, there is provided an electronic mail transmitting and receiving method for a mail server capable of transmitting and receiving mail messages to and from information processing apparatuses each having the same devices as the information processing apparatus described in any one of the first to third modes, the method comprising: storing a specific mail message and monitoring a specified reply time when the specific mail message, the addressee thereof, and the specified reply time are received from any particular information processing apparatus; returning at the specified reply time a query message to the information processing apparatus that originated the specific mail message, and thereby querying the information processing apparatus as to whether or not the specific mail message should be sent out to the addressee; and handling the specific mail message in accordance with a reply received from the information processing apparatus in response to the query message, or transmitting the specific mail message to the addressee when no reply is received.

According to an eighth mode of the invention, there is provided a program storage device readable by a computer to execute the method described in the sixth mode.

According to a ninth mode of the invention, there is provided a program storage device readable by a computer to execute the method described in the seventh mode.

According to the information processing apparatus and the mail server for information processing apparatuses pursuant to the present invention, the user carrying the information processing apparatus creates, before entering an unsafe area, an electronic mail message to the effect that the user may be encountering a dangerous situation and registers the addressee of the message with the mail server; thereafter, when the time specified, for example, for transmission of the mail message arrives, the mail server makes a query to the user and, if the user is not in a dangerous situation, the user performs the operation to cancel the transmission of the mail message, but if the user is facing a dangerous situation and is therefore unable to perform the cancel operation, the preset mail message is automatically transmitted from the mail server to the predesignated addressee, requesting the recipient of the message to take action to save the user from the danger, the invention thus achieving the effect of enhancing the safety of the user.

Further, if the information processing apparatus of the present invention is given to a child who goes out alone to a place where parents cannot keep an eye on the child, and if the addressee of the specific mail message is set to the address of the parent's mobile telephone, while setting the specified time for the time the child is on the way to school and also for the time the child is on the way home from school, then if the child is kidnapped on the way to school or on the way home from school, the situation can be immediately reported to the parents, and the possibility of the child falling into a dangerous situation can thus be reduced.

### BRIEF DESCRIPTION OF THE DRAWINGS

The present invention will be more clearly understood from the description as set forth below with reference to the accompanying drawings, wherein:

FIG. 1 is a system configuration diagram showing the configuration of an information processing apparatus according to the present invention, a mobile telephone network management center containing a mail server according to the present invention, and a mobile telecommunication switching office connected to them;

FIG. 2 is a flowchart illustrating a procedure according to a first embodiment for the specific mail message transmit request and transmission cancel request operations to be performed at the information processing apparatus shown in FIG. 1;

FIG. 3 is a flowchart illustrating a procedure according to the first embodiment for the specific mail message transmission querying and mail message transmitting operations to be performed at the mail server shown in FIG. 1 in response to the operations that the information processing apparatus shown in FIG. 1 performs in accordance with the procedure shown in FIG. 2;

FIG. 4 is a flowchart illustrating a procedure according to a second embodiment for the specific mail message transmit request and transmission cancel request operations to be performed at the information processing apparatus shown in FIG. 1;

FIG. 5 is a flowchart illustrating a procedure according to the second embodiment for the specific mail message transmission querying and mail message transmitting operations to be performed at the mail server shown in FIG. 1 in response to the operations that the information processing apparatus shown in FIG. 1 performs in accordance with the procedure shown in FIG. 4;

FIG. 6 is a flowchart illustrating a procedure according to a third embodiment for the specific mail message transmit request and transmission cancel request operations to be performed at the information processing apparatus shown in FIG. 1;

FIG. 7 is a flowchart illustrating a procedure according to the third embodiment for the specific mail message transmission querying and mail message transmitting operations to be performed at the mail server shown in FIG. 1 in response to the operations that the information processing apparatus shown in FIG. 1 performs in accordance with the procedure shown in FIG. 6;

FIG. 8 is a system configuration diagram showing the configuration of an information processing apparatus equipped with a GPS function according to the present invention, a mobile telephone network management center containing a mail server according to the present invention, and a mobile telecommunication switching office connected to them.

### DESCRIPTION OF THE PREFERRED EMBODIMENTS

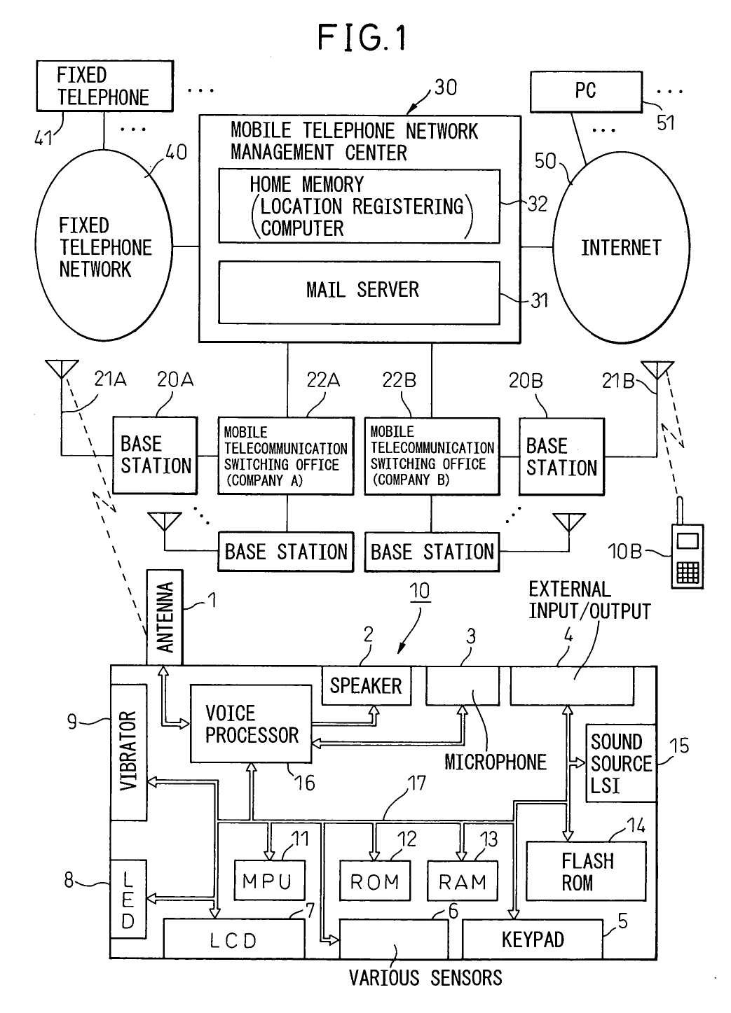

By referring to the accompanying drawings, the preferred mode for carrying out the present invention will be described in detail, below, based on specific embodiments thereof. FIG. 1 is a system configuration diagram showing the configuration of a telecommunication system comprising an information processing apparatus 10 according to the present invention and a mobile telephone network management center 30 containing a mail server 31 according to the present invention.

In the illustrated embodiment, the information processing apparatus 10 is a mobile telephone 10. An antenna 1 is attached to the casing of the mobile telephone 10 which also contains a speaker 2 as a receiver, a microphone 3 as a transmitter, an external input/output terminal 4 in which an earphone is to be inserted, a keypad 5 on which buttons for dialing are arranged, various sensors 6 such as a fingerprint sensor, a liquid crystal display (LCD) 7 for displaying a telephone number, etc., an LED 8 which lights to produce a visual indication, and a vibrator 9 for causing the casing to vibrate when an incoming call arrives. Inside the casing are accommodated a microprocessor unit (MPU) 11 which is responsible for the entire control, memories such as a ROM 12, a RAM 13, and a flash ROM 14, a sound source LSI 15 capable of producing a ringing tone, and a voice processor 16 capable of converting an analog signal such as voice to a digital signal and vice versa, these components being interconnected via an internal bus 17.

If the mobile telephone 10 having the above configuration is a subscriber, for example, to a mobile telephone company A, then of a plurality of base stations 20A connected via radio to a mobile telecommunication switching office 22A of the company A, the mobile telephone 10 can communicate with an antenna 21A of the base station 20A nearest to the mobile telephone 10. The detailed configuration of the mobile telecommunication switching office 22A will not be described here. On the other hand, if the mobile telephone 10 is a subscriber to a mobile telephone company B, then of a plurality of base stations 20B connected via radio to a mobile telecommunication switching office 22B of the company B, the mobile telephone 10 can communicate with an antenna 21B of the base station 20B nearest to the mobile telephone 10.

The mobile telecommunication switching office 22A of the company A and the mobile telecommunication switching office 22B of the company B are both connected to the mobile telephone network management center 30. The mobile telephone network management center 30 contains, in addition to the mail server 31 for temporarily storing mail messages transmitted from the mobile telephone 10, a home memory 32 which is a computer for registering the location of each mobile telephone. The mobile telephone network management center 30 is connected to a fixed telephone network 40 to which fixed telephones are connected nationwide, and is also connected via the Internet 50 to personal computers (each indicated by PC in the figure and hereinafter referred to as the PC) 51 across the world. In this telecommunication system, not only voice communications and exchange of mail messages between different mobile telephones 10, but voice communications between a mobile telephone 10 and a fixed telephone 41, exchange of mail messages with PCs, information acquisition via the Internet, etc. can also be performed.

Here, a description will be given of the case where a mail message is transmitted from the mobile telephone 10. The bearer of the mobile telephone 10, while viewing the liquid crystal display 10, creates a mail message by entering hiragana and/or alphanumeric characters mapped to the individual keys on the keypad 5 or by using “pictorial symbols”, etc. stored in the ROM 12. When the text to be transmitted as a mail message is completed, the bearer of the mobile telephone 10 enters the telephone number or mail address of the recipient by operating the keypad 5, and sends out the mail message by pressing a transmit button.

When the serving mobile telephone company is the company A, the mail message sent out from the mobile telephone 10 is received by the antenna 21A of the base station 20A nearest to the mobile telephone 10 among the base stations 20A connected to the mobile telecommunication switching office 22A, and is transferred from the mobile telecommunication switching office 22A to the mobile telephone network management center 30 where the mail message is temporarily stored on the mail server 31. If the destination of the mail message is a mobile telephone 10B subscribed to another company, in this example, the company B, the mobile telecommunication switching office 22A of the company A queries the mobile telephone network management center 30 about the recipient's location information and, after receiving the reply, connects the line to the base station 20B that covers the location of the destination mobile telephone 10B; then, the base station 20B sends out a paging signal and delivers the mail message to the mobile telephone 10B that responded to the paging signal.

The above has described the conventional mail message transmitting procedure, but the mail message transmitting procedure of the present invention differs from that of the conventional mail system in that if the bearer of the mobile telephone runs into a dangerous situation by entering an unsafe area or by being kidnapped, an alarm message preregistered in the mail server is transmitted in the form of a specific mail message to an acquaintance or a law enforcement agency such as the police, to thereby try to save the bearer from the danger. The transmission of this specific mail message can be effected, for example, by pressing a specific combination of keys on the keypad of the existing mobile telephone or by pressing a separate key specifically provided for that purpose.

Examples of the specific mail message are given below. The specific mail message to a friend or an acquaintance, for example, goes like this: “Bill! This is Tom. When you receive this mail, I am in danger. Please call the police immediately, and ask for help.” When sending the specific mail message directly to the police or other law enforcement agency, the message may go like this: “When this mail arrives, I am in danger and unable to move. Please help.” Further, in the case of the specific mail message from a child to its parents, the message may be like this: “Mother, help!”.

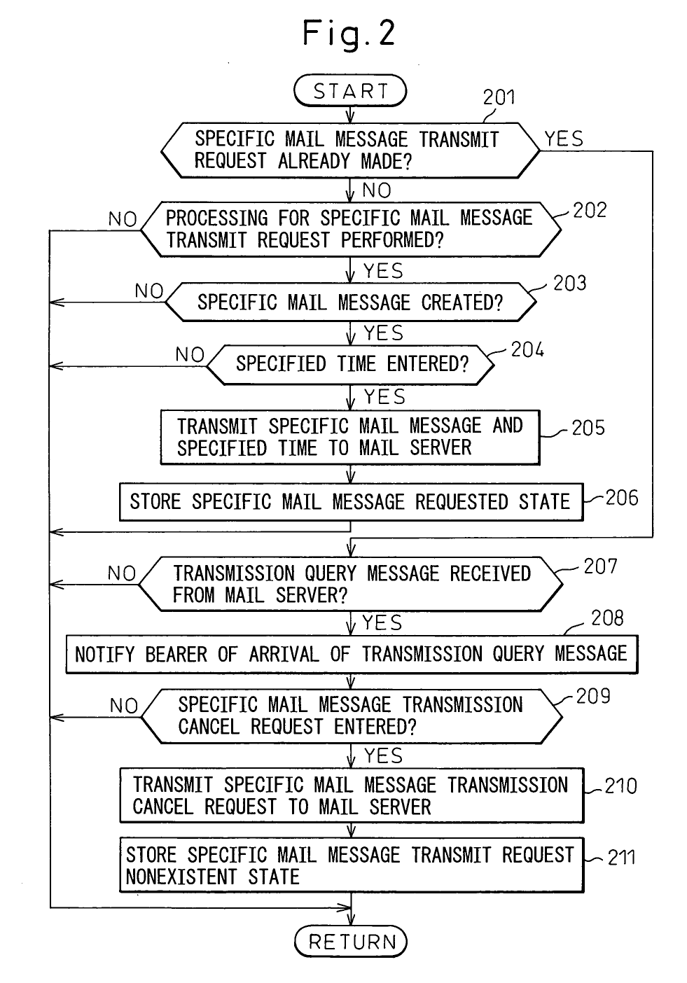

Referring now to the flowcharts of FIGS. 2 to 7, the specific mail message transmitting procedures of the present invention will be described below with reference to three embodiments by dividing the procedures between the operations to be performed at the mobile telephone side and the operations to be performed at the mail server side.

FIG. 2 is a flowchart illustrating the procedure according to the first embodiment for the specific mail message transmit request and transmission cancel request operations to be performed at the mobile telephone 10 as the information processing apparatus shown in FIG. 1. This procedure should be performed by interrupt at predetermined intervals of time after the specific mail message transmitting operation described above has been performed.

In step 201, it is determined whether a specific mail message transmit request has already been made. If the specific mail message transmit request has not yet been made, the process proceeds to step 202. In step 202, it is determined whether processing for the specific mail message transmit request has been performed in the current cycle of the process; if the processing for the specific mail message transmit request has not been performed in the current cycle of process either, this routine is terminated.

On the other hand, if it is determined in step 202 that the processing for the specific mail message transmit request has been performed, the process proceeds to step 203 to determine whether the specific mail message containing the addressee of the mail message has been created. If the specific mail message has not been created yet, this routine is terminated in order to wait until the creation of the specific mail message is completed.

If it is determined in step 203 that the creation of the specific mail message is completed, the process proceeds to step 204 to determine whether the specified time has been entered. The specified time refers to a prescribed time later than the present time, and is entered in order to request the mail server to send a query at the specified time to check whether the bearer of the mobile telephone is safe or not. If it is determined in step 204 that the specified time has not yet been entered, this routine is immediately terminated, but if it is determined that the specified time has been entered, the process proceeds to step 205.

In step 205, the created specific mail message and the specified time are transmitted to the mail server. After the created specific mail message and the specified time have been transmitted to the mail server, the process proceeds to step 206 to store the fact that the specific mail message transmit request has been made to the mail server. Once the fact that the specific mail message transmit request has been made to the mail server is stored, the answer to the decision in step 201 is YES, so that the process proceeds from step 201 to step 207.

In step 207, it is determined whether a specific mail message transmission query message has been received from the mail server. Before the specified time, this transmission query message does not arrive so that, for the time being, the answer to the decision in step 207 is NO and this routine is therefore terminated. On the other hand, when the specified time arrives, the transmission query message is received from the mail server. In this case, the process proceeds to step 208 to notify the bearer of the mobile telephone that the transmission query message has arrived. This can be accomplished, for example, by producing music or a tone or by vibrating the built-in vibrator. Here, the setting may be made so that the notification is delivered in the form of a mail message arriving from a predetermined anonymous person, or the arrival of the message may be signaled by producing a receiving tone different from the usual mail receiving tone.

After the bearer of the mobile telephone has been notified in step 208 of the arrival of the transmission query message, it is determined in step 209 whether a specific mail message transmission cancel request has been entered. If the specific mail message transmission cancel request has not been entered, this routine is immediately terminated, but if the specific mail message transmission cancel request has been entered, the process proceeds to step 210 to transmit the specific mail message transmission cancel request to the mail server; then, in step 211, the specific mail message transmit request nonexistent state is stored, after which the routine is terminated.

When the specific mail message transmission cancel request is entered in step 209, this indicates that the bearer of the mobile telephone is safe, but if the specific mail message transmission cancel request has not been entered within a predetermined time, this implies that the bearer of the mobile telephone is not safe. The determination as to whether the bearer of the mobile telephone is safe or not is made at the mail server side as will be described hereinafter.

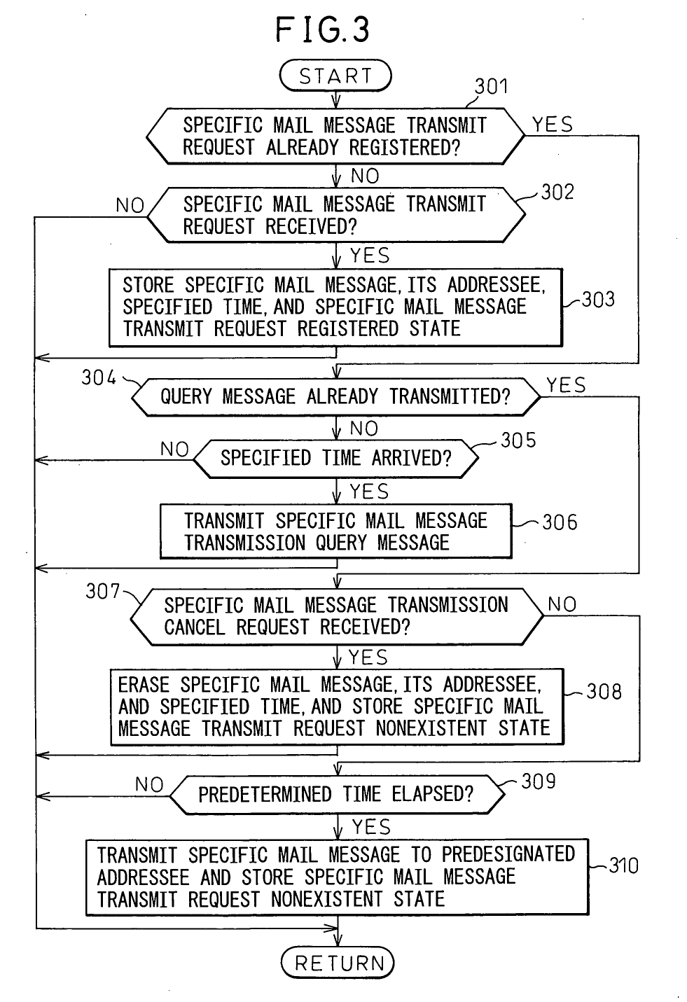

FIG. 3 is a flowchart illustrating the procedure according to the first embodiment for the specific mail message transmission querying and mail message transmitting operations to be performed at the mail server 31 shown in FIG. 1 in response to the operations that the mobile telephone 10 as the information processing apparatus shown in FIG. 1 performs in accordance with the procedure shown in FIG. 2. The following procedure is performed at predetermined intervals of time for each particular mobile telephone that has transmitted the specific mail message transmit request. The following describes the procedure only for one particular mobile telephone that has transmitted the specific mail message transmit request.

In step 301, when the specific mail message transmit request is received from any particular mobile telephone, it is determined whether the specific mail message transmit request has already been registered. If the specific mail message transmit request has not been registered yet, the process proceeds to step 302 to determine whether the specific mail message transmit request has been fully received. Before the specific mail message transmit request is fully received, the answer to the decision in step 302 is NO, and this routine is therefore terminated; when the specific mail message transmit request has been fully received, the process proceeds to step 303, and the specific mail message, the addressee of the mail message, and the specified time at which the specific mail message transmission query message is to be transmitted (returned) to the mobile telephone are stored, while also storing the specific mail message request registered state, after which this routine is terminated.

After the processing in step 303 is completed, the answer to the decision in step 301 is YES, so that the process proceeds from step 301 to step 304. In step 304, it is determined whether the specific mail message transmission query message has already been transmitted to the mobile telephone. If the specific mail message transmission query message has not yet been transmitted to the mobile telephone, the process proceeds to step 305 to determine whether the specified time stored in step 303 has arrived or not. If the specified time has not yet arrived, this routine is terminated, but if the specified time has arrived, the process proceeds to step 306 to transmit the specific mail message transmission query message to the mobile telephone, after which this routine is terminated.

After the specific mail message transmission query message has been transmitted to the mobile telephone in step 306, the answer to the decision in step 304 is YES, and the process proceeds to step 307. In step 307, it is determined whether the specific mail message transmission cancel request has been received from the mobile telephone. If the specific mail message transmission cancel request has been received from the mobile telephone, the process proceeds to step 308 where the specific mail message, the addressee of the mail message, and the specified time are erased, and the specific mail message transmit request nonexistent state is stored, after which this routine is terminated.

On the other hand, if it is determined in step 307 that the specific mail message transmission cancel request has not been received from the mobile telephone, the process proceeds to step 309. In step 309, it is determined whether a predetermined time has elapsed from the time that the query message was transmitted in step 306. If the predetermined time has not yet elapsed, this routine is terminated, but if the predetermined time has elapsed, the process proceeds to step 310 to transmit the specific mail message to the predesignated addressee. After the specific mail message has been transmitted to the predesignated addressee, the specific mail message, the addressee of the mail message, and the specified time are erased, and the specific mail message transmit request nonexistent state is stored, after which this routine is terminated.

Here, if the specific mail message transmission cancel request has not been received from the mobile telephone within the predetermined time, then rather than transmitting the specific mail message to the predesignated addressee upon the expiration of the predetermined time the query message may be transmitted once again to the mobile telephone to make sure and recheck that there is no specific mail message transmission cancel request from the mobile telephone.

Further, if provisions are made so that the specific mail message transmission cancel request is entered by pressing a specific combination of keys selected from the plurality of keys on the keypad of the mobile telephone, entry of the specific mail message transmission cancel request by a third party can be prevented. Further, the specific mail message transmission cancel request may be transmitted in the form of an encrypted mail message to the mail server. Furthermore, a dummy cancel request may be preset in addition to the specific mail message transmission cancel request. By so doing, when the query message is received, if the bearer of the mobile telephone is in danger, for example, by being restrained by a criminal and is ordered by the criminal to respond to the query message, the bearer of the mobile telephone can enter the dummy cancel request for transmission to the mail server; then, the mail server can recognize the degree of the danger confronting the bearer of the mobile telephone and transmit the specific mail message to the specified addressee to notify the police or other law enforcement agency accordingly.

In an alternative embodiment, when there is no response to the query message from the mobile telephone, the query message may be transmitted repeatedly at predetermined intervals of time to the information processing apparatus even after the specific mail message has been transmitted to the predesignated addressee. Here, provisions may be made to transmit a preregistered emergency mail message to a law enforcement agency (for example, the police) when the number of retransmissions of the query message has exceeded a reference value.

With the above procedure, when the bearer of the mobile telephone that requested the transmission of the specific mail message has received the specific mail transmission query message from the mail server, if the bearer of the mobile telephone is in a safe condition, the transmission of the specific mail message can be canceled, but if the bearer is not in a safe condition, the bearer cannot perform the operation to cancel the transmission of the specific mail message, and the specific mail message is therefore transmitted from the mail server to the predesignated addressee. As a result, the acquaintance or the law enforcement agency that received the specific mail message takes action to rescue the bearer of the mobile telephone, and the probability of restoring the safety of the bearer of the mobile telephone thus increases.

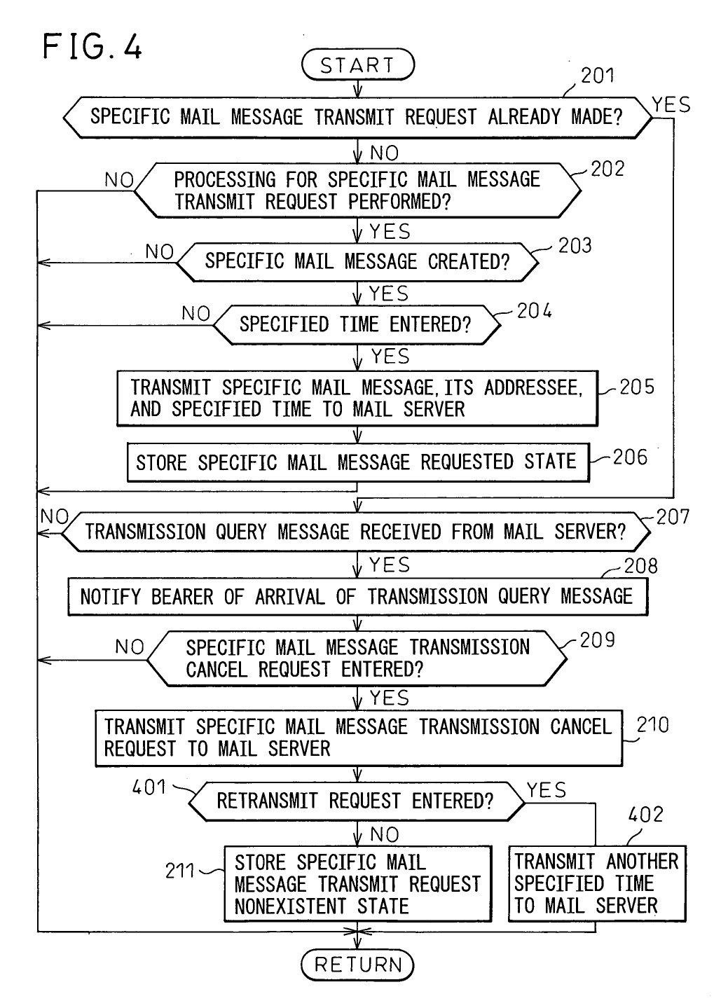

FIG. 4 is a flowchart illustrating the procedure, according to the second embodiment, for the specific mail message transmit request and transmission cancel request operations to be performed at the mobile telephone 10 as the information processing apparatus shown in FIG. 1. The procedure of the second embodiment is a modification of the procedure of the first embodiment shown in FIG. 2 and, as in the first embodiment, this procedure is performed by interrupt at predetermined intervals of time after the specific mail message transmitting operation has been performed.

The procedure of the second embodiment of the specific mail message transmit request and transmission cancel request operations performed at the mobile telephone 10 differs from that of the first embodiment only in that, after requesting the mail server to cancel the specific mail message transmit request in step 210 in the first embodiment, a request is made to the mail server to retransmit the specific mail message transmission query message at another specified time. Accordingly, the procedure from step 201 to 210 in the second embodiment is exactly the same as that of the first embodiment, and therefore, the description of these steps will not be repeated here.

In the first embodiment, at the specified time, i.e., when the predetermined time has elapsed after sending the specific mail message transmit request, a request was sent to the mail server to cancel the specific mail message transmit request; however, there are cases where, at the specified time, the bearer of the mobile telephone is safe but is still in an unsafe area. In such cases, there can occur a situation where there arises a need to retransmit the specific mail message transmission query message at another specified time. The second embodiment addresses such a situation.

In the second embodiment, after requesting the mail server to cancel the specific mail message transmit request in step 210, the process proceeds to step 401 to determine whether the specific mail message transmit request has been entered once again. If there is no such specific mail message transmit request, the process proceeds to step 211 where the specific mail message transmit request nonexistent state is stored, as in the first embodiment, after which this routine is terminated. On the other hand, if it is determined in step 401 that the specific mail message transmit request has been entered once again, the process proceeds to step 402 to transmit another specified time, after which this routine is terminated.

Thus, the mobile telephone repeats the earlier described process from step 201 to step 210 until it is determined that there is no specific mail message transmit request in step 401 after step 210. That is, in the procedure of the second embodiment, a request for the transmission of the specific mail message transmission query message can be made repeatedly as long as the bearer of the mobile telephone stays in an unsafe area.

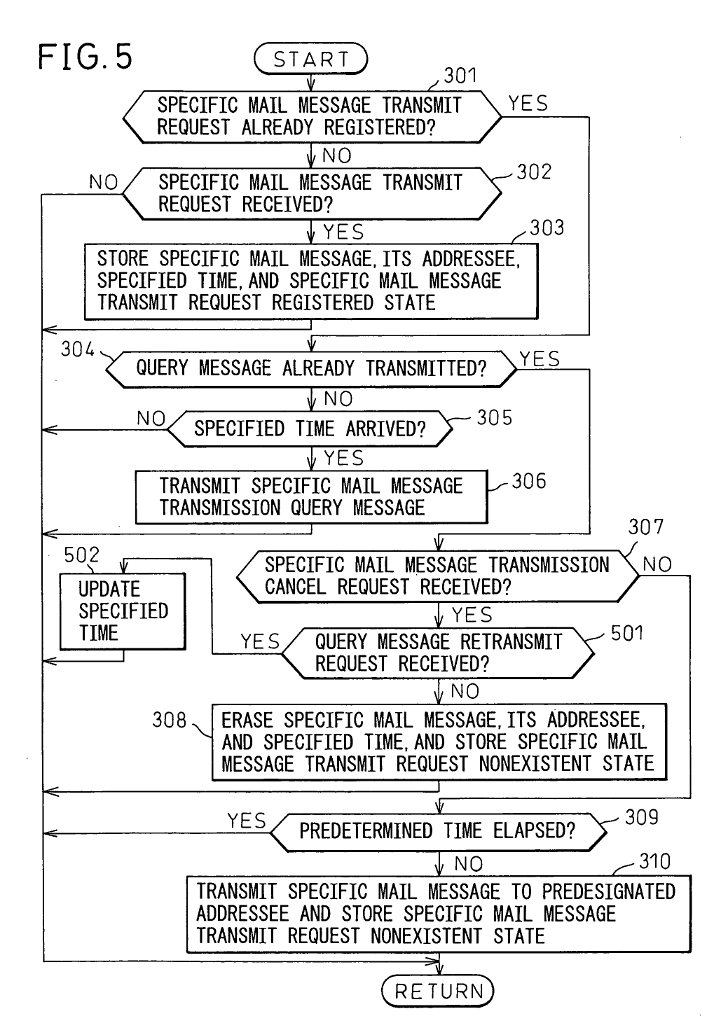

FIG. 5 is a flowchart illustrating the procedure according to the second embodiment for the specific mail message transmission querying and mail message transmitting operations to be performed at the mail server 31 shown in FIG. 1 in response to the operations that the mobile telephone 10 as the information processing apparatus shown in FIG. 1 performs in accordance with the procedure shown in FIG. 4. This procedure is substantially the same as the procedure of the first embodiment of the mail server operations shown in FIG. 3, the only difference being in the part of the procedure that corresponds to the part where the procedure of the second embodiment of the mobile telephone operations shown in FIG. 4 differs from the procedure of the first embodiment of the mobile telephone operations shown in FIG. 2.

More specifically, the second embodiment of the mail server operations shown in FIG. 5 differs from the first embodiment of the mail server operations shown in FIG. 3 only in that steps 501 and 502 are inserted between the steps 307 and 308. Accordingly, of the steps in the second embodiment of the mail server operations shown in FIG. 5, the same steps as those in the first embodiment of the mail server operations shown in FIG. 3 are designated by the same step numbers, and the description of such steps will not be repeated here.

In the procedure of the first embodiment of the mail server operations shown in FIG. 3, when the specific mail message transmission cancel request was received from the mobile telephone in step 307, the process proceeded to step 308 where the specific mail message, the addressee of the mail message, and the specified time were erased, and the specific mail message transmit request nonexistent state was stored, after which the routine was terminated. In contrast, in the second embodiment of the mail server operations, when the specific mail message transmission cancel request is received from the mobile telephone in step 307, the process proceeds to step 501 before proceeding to step 308, and it is determined in step 501 whether a query message retransmit request has been received from the mobile telephone.

If it is determined in step 501 that no query message retransmit request has been received from the mobile telephone then, as in the first embodiment of the mail server operations, the process proceeds to step 308 where the specific mail message, the addressee of the mail message, and the specified time are erased, and the specific mail message transmit request nonexistent state is stored, after which the routine is terminated. On the other hand, if it is determined in step 501 that a query message retransmit request has been received from the mobile telephone, the process proceeds to step 502. In step 502, the specified time is updated, and the routine is terminated. In this case, the specific mail transmission query message is retransmitted from the mail server to the mobile telephone at the specified time thus updated.

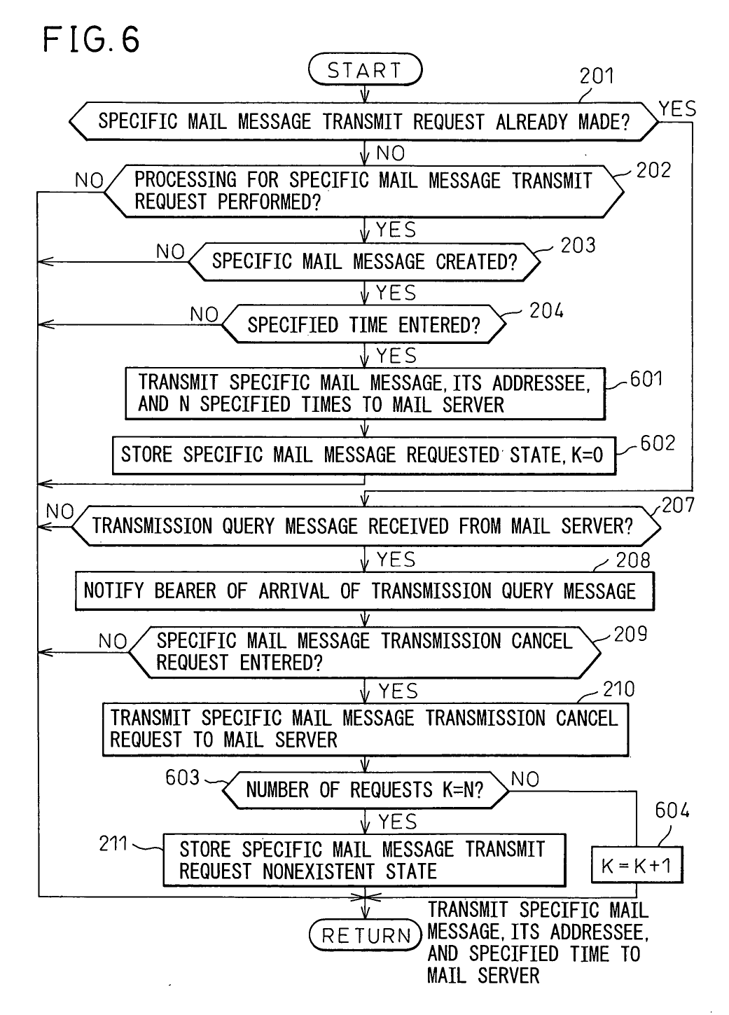

FIG. 6 is a flowchart illustrating the procedure according to the third embodiment for the specific mail message transmit request and transmission cancel request operations to be performed at the mobile telephone 10 as the information processing apparatus shown in FIG. 1. The procedure of the third embodiment is a modification of the procedure of the first embodiment described with reference to FIG. 2; as in the first embodiment, this procedure is performed by interrupt at predetermined intervals of time after the specific mail message transmitting operation has been performed.

The procedure of the third embodiment of the specific mail message transmit request and transmission cancel request operations performed at the mobile telephone 10 differs from that of the first embodiment in that the steps 205 and 206 in the first embodiment are replaced by steps 601 and 602, and in that steps 603 and 604 are inserted between the steps 210 and 211. Accordingly, of the steps 201 to 211 in the third embodiment, the same steps as those in the first embodiment are designated by the same step numbers, and the description of such steps will not be repeated here.

To describe the process more specifically, in the first embodiment, only one specified time was transmitted to the mail server in step 205, but in the second embodiment a plurality (N) of specified times are transmitted to the mail server in step 601. The plurality of specified times may be set so as to occur at equally spaced intervals, but alternatively, the plurality of specified times may be set so as to occur a plurality of times, for example, while the child is on the way to school, and a plurality of times while the child is on the way home from school. Further, in the first embodiment, the fact that the specific mail message transmit request has been made to the mail server was stored in step 206, whereupon the routine was terminated, but in the third embodiment, the processing for setting a count value K to 0 is added, the count value K representing a count of the number of specified times requested.

In the first embodiment, if it was determined in step 209 that the specific mail message transmission cancel request had been entered, the process proceeded to step 210 to transmit the specific mail message transmission cancel request to the mail server; then, the specific mail message transmit request nonexistent state was stored in step 211, after which the routine was terminated. On the other hand, in the third embodiment, if it is determined in step 209 that the specific mail message transmission cancel request has been entered, the process proceeds to step 603 where it is determined whether the count value K of the number of transmission query message transmit requests has reached N.

When the count value K of the number of transmission query message transmit requests has reached N, then the specific mail transmit request nonexistent state is stored in step 211 as in the first embodiment, after which the routine is terminated. On the other hand, if it is determined in step 603 that the count value K of the number of transmission query message transmit requests has not yet reached N, the process proceeds to step 604 where the count value K of the number of transmission query message transmit requests is incremented by 1, after which the routine is terminated.

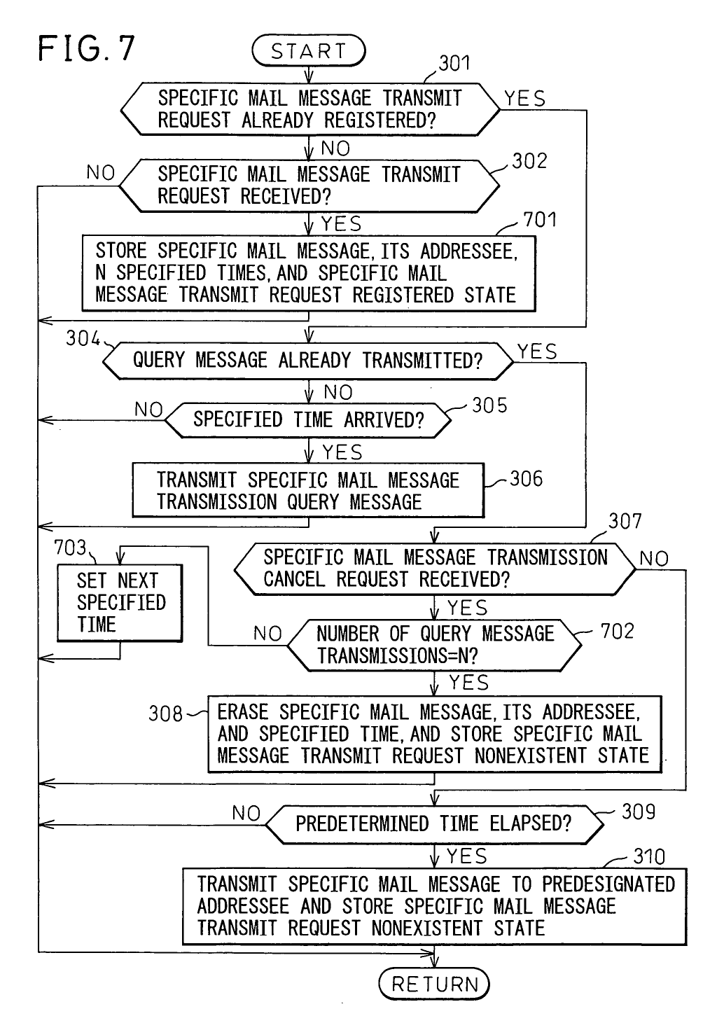

FIG. 7 is a flowchart illustrating the procedure according to the third embodiment for the specific mail message transmission querying and mail message transmitting operations to be performed at the mail server 31 shown in FIG. 1 in response to the operations that the mobile telephone 10 as the information processing apparatus shown in FIG. 1 performs in accordance with the procedure shown in FIG. 6. This procedure is substantially the same as the procedure of the first embodiment of the mail server operations shown in FIG. 3, the only difference being in the part of the procedure that corresponds to the part where the procedure of the third embodiment of the mobile telephone operations shown in FIG. 6 differs from the procedure of the first embodiment of the mobile telephone operations shown in FIG. 2.

More specifically, the third embodiment of the mail server operations shown in FIG. 7 differs from the first embodiment of the mail server operations shown in FIG. 3 in that the step 303 in the first embodiment is replaced by step 701, and in that steps 702 and 703 are inserted between the steps 307 and 308. Accordingly, of the steps in the third embodiment of the mail server operations shown in FIG. 7, the same steps as those in the first embodiment of the mail server operations shown in FIG. 3 are designated by the same step numbers, and the description of such steps will not be repeated here.

In the procedure of the first embodiment of the mail server operations shown in FIG. 3, only one specified time was stored; on the other hand, in the third embodiment, a plurality (N) of specified times are stored in step 701. Further, in the procedure of the first embodiment of the mail server operations, when the specific mail message transmission cancel request was received from the mobile telephone in step 307, the process proceeded to step 308 where the specific mail message, the addressee of the mail message, and the specified time were erased, and the specific mail message transmit request nonexistent state was stored, after which the routine was terminated. By contrast, in the third embodiment of the mail server operations, when the specific mail message transmission cancel request is received from the mobile telephone in step 307, the process proceeds to step 702 before proceeding to step 308, and it is determined in step 702 whether the number of query message transmissions has reached N.

If it is determined in step 702 that the number of query message transmissions has reached N, the process proceeds to step 308, as in the first embodiment of the mail server operations, where the specific mail message, the addressee of the mail message, and the specified time are erased, and the specific mail message transmit request nonexistent state is stored, after which the routine is terminated. On the other hand, if it is determined in step 702 that the number of query message transmissions has not yet reached N, the process proceeds to step 703. In step 703, the next specified time is set, after which the routine is terminated. In this case, the specific mail message transmission query message is transmitted from the mail server to the mobile telephone when each of the N specified times arrives.

In the third embodiment, provisions may be made so that the bearer of the mobile telephone can cancel the specific mail message transmit request and the query message return request by operating designated keys on the keypad of the mobile telephone when the bearer of the mobile telephone has left the unsafe area and entered a safe area, making the transmission of the query message no longer necessary, before the number of query message transmissions reaches N.

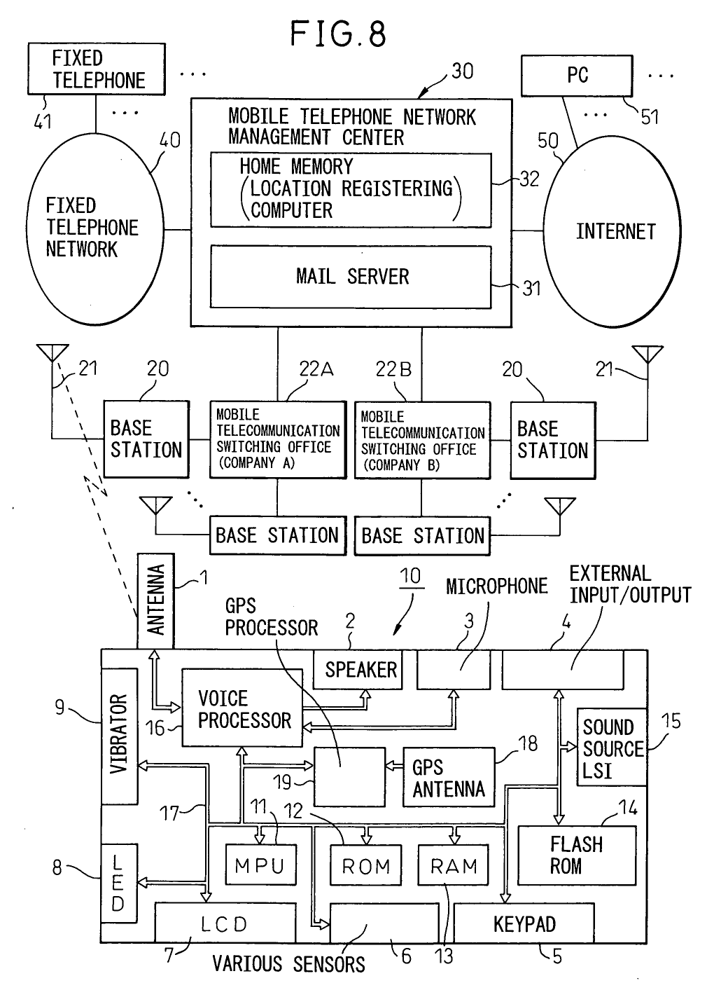

FIG. 8 is a system configuration diagram showing the configuration of a telecommunication system comprising a mobile telephone 10 equipped with a GPS function according to the present invention and a mobile telephone network management center 30 containing a mail server 31 according to the present invention. The mobile telephone 10 of this embodiment includes a GPS antenna 18 and a GPS processor 19 in addition to the component elements shown in FIG. 1. Accordingly, the mobile telephone 10 of this embodiment can determine its geographical location on the Earth by using the GPS antenna 18 and the GPS processor 19 and can transmit the location information to the base station 20 by attaching it to a mail message.

In the case of the mobile telephone 10 equipped with the GPS function according to this embodiment, when the mobile telephone 10 has received a specific mail message query message from the mail server 31, if the bearer of the mobile telephone 10 has not performed the operation to cancel the specific mail message transmission request, the present location of the mobile telephone 10 on the Earth can be transmitted to the server 31 without being noticed by any person around the mobile telephone 10. With this function, when the bearer of the mobile telephone 10 has fallen into a dangerous situation, and the specific mail message is transmitted to its predesignated addressee, the present location of the mobile telephone 10 on the Earth is transmitted from the mobile telephone to the mail server 31, so that the received information can be used when rescuing the bearer of the mobile telephone 10.

Furthermore, provisions can also be made so that if the bearer of the mobile telephone 10 has not performed the operation to cancel the specific mail message transmission request in response to the specific mail message query message received from the mail server 31, the present location of the mobile telephone 10 on the Earth is repeatedly transmitted to the mail server 31 at predetermined intervals of time without being noticed by any person around the mobile telephone 10. With this function, when the bearer of the mobile telephone 10 has fallen into a dangerous situation, and the specific mail message is transmitted to its predesignated addressee, the present location of the mobile telephone 10 on the Earth is thereafter transmitted repeatedly from the mobile telephone to the mail server 31, so that the received information can be made use of when rescuing the bearer of the mobile telephone 10.

Here, if provisions are made to transmit the present location of the mobile telephone 10 on the Earth to the mail server 31 even when the bearer of the mobile telephone 10 has performed the operation to cancel the specific mail message transmission request in response to the specific mail message query message received from the mail server 31, then if the bearer of the mobile telephone 10 has thereafter fallen into a dangerous situation, the task of rescuing the bearer of the mobile telephone becomes easier because the previous location of the mobile telephone 10 can be known.

While the above description has been given by taking the mobile telephone as an example of the information processing apparatus, it will be recognized that the invention is not limited to mobile telephones but is also applicable to various other types of information processing apparatus. Further, a portable information terminal may be used as the information processing apparatus.

The present invention has been described in detail above with reference to the preferred embodiments thereof. To facilitate understanding of the present invention, specific embodiments of the invention are set forth in the following claims.

What is claimed is:

1. An information processing apparatus equipped with an electronic mail transmitting and receiving unit, comprising:
a device which transmits a precreated specific mail message and an addressee thereof to a mail server and requests said mail server to return at a specified time a query message querying whether to send out or not send out said specific mail message to said addressee; and
a device which requests said mail server, in response to said query message returned from said mail server, to cancel the transmission of said specific mail message to said addressee.

2. An information processing apparatus as claimed in claim 1, further comprising a device which requests said mail server, in response to said query message returned from said mail server, to cancel the transmission of said specific mail message for the present and requests again said mail server to return at another specified time a query message querying whether to send out or not send out said specific mail message.

3. An information processing apparatus as claimed in claim 1, wherein said specified time is set as a plurality of different times.

4. An information processing apparatus as claimed in claim 1, wherein when said query message is received, a receiving tone different from a usual mail receiving tone is generated.

5. An information processing apparatus as claimed in claim 1, wherein said specific mail message contains a message to the effect that the bearer of said information processing apparatus is in a dangerous situation and therefore asks the receiver of said mail message to notify a law enforcement agency accordingly.

6. An information processing apparatus as claimed in claim 1, wherein the device which requests said mail server to cancel the transmission of said specific mail message to said addressee is operated by pressing a combination of keys selected from among a plurality of keys provided on a keypad of a mobile telephone.

7. An information processing apparatus as claimed in claim 1, wherein the device which requests said mail server to cancel the transmission of said specific mail message to said addressee transmits an encrypted mail message from a mobile telephone to said mail server.

8. An information processing apparatus as claimed in claim 1, further comprising a GPS device, and wherein
when said query message is received from said mail server, data concerning present location on the Earth is transmitted to said mail server in addition to a reply mail message to said mail server or when no reply is returned to said mail server.

9. A mail server capable of transmitting and receiving mail messages to and from information processing apparatuses each having the same devices as the information processing apparatus of claim 1, said mail server comprising:
a device which stores a specific mail message and monitors a specified reply time when said specific mail message, an addressee thereof, and said specified reply time are received from any particular information processing apparatus;
a device which returns at said specified reply time a query message to the information processing apparatus that originated said specific mail message, and thereby querying said information processing apparatus as to whether or not said specific mail message should be sent out to said addressee; and
a device which handles said specific mail message in accordance with a reply received from said information processing apparatus in response to said query message, or transmits said specific mail message to said addressee when no reply is received.

10. A mail server as claimed in claim 9, wherein said reply from said information processing apparatus is a request to cancel the transmission of said specific mail message to said addressee, or a request to return at another specified time a query message querying whether to send out or not send out said specific mail message to said addressee.

11. A mail server as claimed in claim 9, further comprising a device which transmits a precreated emergency mail message to a predesignated law enforcement agency when a prescribed dummy mail message is received from said information processing apparatus in response to said query message.

12. A mail server as claimed in claim 9, further comprising:
a device which continues to transmit, after first transmitting said query message, said query message to said information processing apparatus repeatedly at predetermined intervals of time when no reply is received in response to said query message; and
a device which transmits a precreated emergency mail message to a predesignated law enforcement agency when the number of retransmissions of said query message has exceeded a reference value.

13. A mail server as claimed in claim 9,
said information processing apparatus further comprising a GPS device, and wherein when said query message is received from said mail server, data concerning present location on the Earth is transmitted to said mail server in addition to a reply mail message to said mail server or when no reply is returned to said mail server,
said mail server further comprising a device which transmits a precreated emergency mail message to a predesignated law enforcement agency, along with data concerning location of said information processing apparatus on the Earth, when no reply is received in response to said query message but the data concerning the location of said information processing apparatus on the Earth is received from said information processing apparatus.

14. A mail server as claimed in claim 9, wherein said specific mail message contains a message to the effect that the bearer of said information processing apparatus is in a dangerous situation and therefore asks the receiver of said mail message to notify a law enforcement agency accordingly, and wherein said law enforcement agency is a police station.

15. An electronic mail transmitting and receiving method for an information processing apparatus, comprising:
transmitting a precreated specific mail message and an addressee thereof to a mail server;
requesting said mail server to return at a specified time a query message querying whether to send out or not send out said specific mail message to said addressee; and
requesting said mail server, in response to said query message returned from said mail server, to cancel the transmission of said specific mail message to said addressee.

16. An electronic mail transmitting and receiving method for a mail server capable of transmitting and receiving mail messages to and from information processing apparatuses each having the same devices as the information processing apparatus of claim 1, said method comprising:
storing a specific mail message and monitoring a specified reply time when said specific mail message, an addressee thereof, and said specified reply time are received from any particular information processing apparatus;
returning at said specified reply time a query message to the information processing apparatus that originated said specific mail message, and thereby querying said information processing apparatus as to whether or not said specific mail message should be sent out to said addressee; and
handling said specific mail message in accordance with a reply received from said information processing apparatus in response to said query message, or transmitting said specific mail message to said addressee when no reply is received.

17. A program storage device readable by a machine, tangibly embodying a program of instructions executable by the machine to perform method steps for an information processing apparatus to transmit and receive an electronic mail, said method steps comprising:
transmitting a precreated specific mail message and an addressee thereof to a mail server;
requesting said mail server to return at a specified time a query message querying whether to send out or not send out said specific mail message to said addressee; and
requesting said mail server, in response to said query message returned from said mail server, to cancel the transmission of said specific mail message to said addressee.

18. A program storage device readable by a machine, tangibly embodying a program of instructions executable by the machine to perform method steps for a mail server capable of transmitting and receiving mail messages to and from information processing apparatuses each having the same devices as the information processing apparatus of claim 1 to transmit and receive an electronic mail, said method steps comprising:
storing a specific mail message and monitoring a specified reply time when said specific mail message, an addressee thereof, and said specified reply time are received from any particular information processing apparatus;
returning at said specified reply time a query message to the information processing apparatus that originated said specific mail message, and thereby querying said information processing apparatus as to whether or not said specific mail message should be sent out to said addressee; and
handling said specific mail message in accordance with a reply received from said information processing apparatus in response to said query message, or transmitting said specific mail message to said addressee when no reply is received.

19. An information processing apparatus as claimed in claim 1, wherein said information processing apparatus is a portable information terminal.
